(19) United States
(12) Patent Application Publication
(10) Pub. No.: US 2007/0273537 A1
(43) Pub. Date: Nov. 29, 2007

(54) COMBINED SYSTEM FOR TRACKING OFFENDER REHABILITATION

(75) Inventors: Pierre M. Crespo, Burkesville, KY (US); Michael Rader, Ashland, PA (US)

Correspondence Address: FERENCE & ASSOCIATES LLC, 409 BROAD STREET, PITTSBURGH, PA, 15143, US

(73) Assignee: Dolphin International Resources, LLC,, Cleona, PA (US)

(21) Appl. No.: 11/737,132

(22) Filed: Apr. 18, 2007

Related U.S. Application Data
(60) Provisional application No. 60/792,849, filed on Apr. 18, 2006.

(51) Int. Cl. G08B 23/00; B60R 25/04

(52) U.S. Cl. 340/576; 180/272

(57) ABSTRACT

A combined testing and tracking system that includes a breath alcohol ignition interlock, a personal portable breath test monitor, and an EMHA (Electronic Monitoring Home Arrest) system. These may preferably work in concert to provide a unitary system whose efficiency and effectiveness vastly exceed the sum of its individual parts.

### CLAIM OF PRIORITY

This application claims priority from U.S. Provisional Patent Application Ser. No. 60/792,849, filed on Apr. 18, 2006, which is hereby filly incorporated by reference as if set forth in its entirety herein.

### FIELD OF THE INVENTION

The present invention relates to systems and arrangements for testing and tracking offenders such as DUI offenders.

### BACKGROUND OF THE INVENTION

Numerous systems have been developed for testing and tracking offenders such as DUI (driving under the influence) offenders. Among such systems are a wide variety of ignition interlock arrangements for motor vehicles, where the vehicle cannot be started without the offender passing a breath test in the vehicle. Challenges have long been addressed in that connection, as well, including the positive identification of the offender.

Despite the advances made to date, however, a highly compelling need has been recognized in connection with providing a versatile, all-encompassing system that can test and track offenders in a more thorough manner that would reduce even more the likelihood of an offender circumventing the system.

### SUMMARY OF THE INVENTION

Broadly contemplated herein, in accordance with at least one presently preferred embodiment of the present invention, is a combined testing and tracking system that includes a breath alcohol ignition interlock, a personal portable breath test monitor, and an EMHA (Electronic Monitoring Home Arrest) system. These may preferably work in concert to provide a unitary system whose efficiency and effectiveness vastly exceed the sum of its individual parts.

In summary, one aspect of the invention provides a monitoring system comprising: a vehicle ignition interlock device; an EMHA device; and a mobile breath test arrangement; the vehicle ignition interlock device, the EMHA device and the mobile breath test arrangement being configured for mutual data exchange.

### BRIEF DESCRIPTION OF THE DRAWINGS

FIG. 1 schematically illustrates a 3-component system for monitoring and tracking.

FIG. 2 schematically illustrates an ignition interlock component.

FIG. 3 schematically illustrates an EMHA component.

FIG. 4 schematically illustrates a personal breath test component.

### DETAILED DESCRIPTION OF THE PREFERRED EMBODIMENTS

For a better understanding of the present invention, together with other and further features and advantages thereof, reference is made to the following description, taken in conjunction with the accompanying drawings, and the scope of the invention will be pointed out in the appended claims.

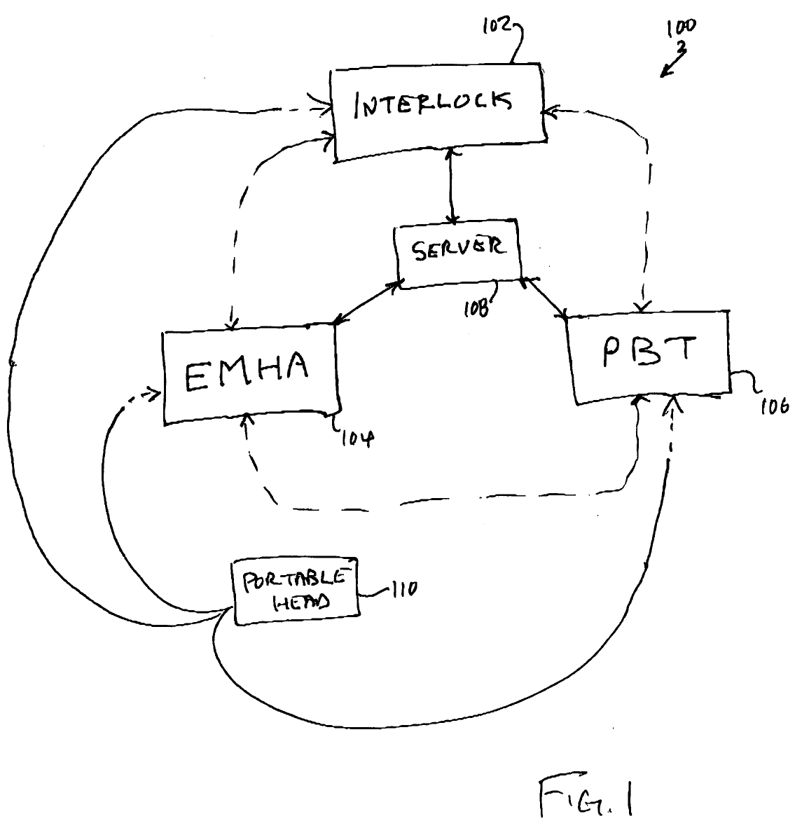

It will be readily understood that the components of the present invention, as generally described and illustrated in the Figures herein, may be arranged and designed in a wide variety of different configurations. Thus, the following more detailed description of the embodiments of the apparatus, system, and method of the present invention, as represented in FIGS. 1 through 4, is not intended to limit the scope of the invention, as claimed, but is merely representative of selected embodiments of the invention.

Reference throughout this specification to “one embodiment” or “an embodiment” (or the like) means that a particular feature, structure, or characteristic described in connection with the embodiment is included in at least one embodiment of the present invention. Thus, appearances of the phrases “in one embodiment” or “in an embodiment” in various places throughout this specification are not necessarily all referring to the same embodiment.

The illustrated embodiments of the invention will be best understood by reference to the drawings, wherein like parts are designated by like numerals or other labels throughout. The following description is intended only by way of example, and simply illustrates certain selected embodiments of devices, systems, and processes that are consistent with the invention as claimed herein.

Generally, ignition interlock, EMHA, and personal breath testers are three separate pieces of monitoring devices used in the areas of corrections, criminal sentencing requirements, and legislative mandates, as imposed upon defendants with in the supervision or authority of a jurisdiction. Broadly contemplated herein is an arrangement which essentially integrates the functioning of these three separate devices into one product. Accordingly, as shown in FIG. 1, a “three in one” system 100 may preferably include an ignition interlock 102, EMHA 104 and personal breath tester 106 in communication with a common server 108; the three components 102/104/106 may also to some degree be in communication with one another as shown by the dotted lines. As will be appreciated herebelow, a common portable data sample head 110 can preferably be integrated into all three component systems 102/104/106 to facilitate coordination of the three systems 102/104/106 with each other.

Preferably, as shown in FIG. 1, a first component of the “three in one” system broadly contemplated herein is breath alcohol ignition interlock device 102 which may optionally include a positive identification camera 111. It is assumed such a base interlock device will meet or exceed all National Highway Traffic Safety Agency (NHTSA) standard requirements for the certification of an interlock on the Certified Products List (CPL).

In accordance with a presently preferred embodiment, portable data sample head 110 is capable as a breath sample head, is preferably wireless and contains data memory (110a) from user activity. The head 110 is preferably configured to communicate data to a relay logger 112 (positioned, e.g., under the vehicle dash) that also holds data memory. A power charger cradle 114, preferably affixed in safe sight of the driver, will allow the head 110 to be attached in a stable manner and to maintain a charge in a battery contained in the head 110. The cradle 114 also allows for the aforementioned optional camera 111 to be mounted for the positive identification of a driver using the interlock device 102. Preferably, in concert with the camera 114, bio-metric facial recognition software 116 is included to aid in positive identification. Alternatively or in addition, positive identification can also be effected via voice recognition software 118 and/or finger print identification software 120. Titanium Technology Ltd. of Menlo Park, Calif. provides face recognition software that is found to be particularly advantageous in the context of embodiments of the present invention. The Well Company (Well-Co) of Hong Kong produces ignition interlock equipment having components that also can be made use of in the context of embodiments herein.

The interlock device 102 is capable of transmitting data to server 108 (e.g., a server associated with the monitoring/testing provider) via cellular, GSM, DSL, or radio frequency technology, or any other suitable transmission medium. An operator using the server 108 can likewise access the interlock device 102 as needed or desired.

Preferably, the interlock device 102, via an appropriate input arrangement (not shown) is associated with user programmable codes that allow for disabling of interlocking functions for vehicle service requirements at a vehicle repair facility. A repair facility can also re-enter a code after repair to re-initiate the interlock for the defendant. The same type of code procedure can allow for a grace period to be entered after expiration of time in the data logger resulting from a missed appointment or exceeding a violation limit. The interlock device 102 is also preferably capable of using a vehicle's OBD II connection for starter interrupt and positive and negative wire connections.

By way of some preferred refinements, the sample head 110 can preferably contain an LED screen to communicate with the user. It may also have an optional bogus air anti-thwarting device using a voice tone procedure. Finally, the head is preferably GPS-capable for tracking the defendant/offender and associated equipment.

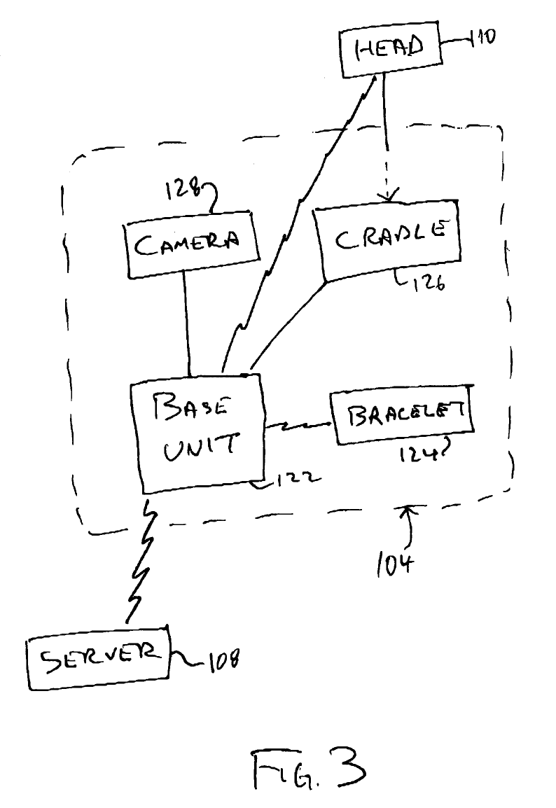

Preferably, as shown in FIG. 3, a second component of the three-component system is embodied by EMHA device 104. A general discussion of EMHA, for background purposes, can be found at http://www.mentormunicipalcourt.org/faq.shtml#EMHA_Electronic_Monitoring_House.

Preferably, a EMHA base unit 122 will power into an AC home outlet and may use a phone line for data transfer to server 108 or may use cellular, GSM, DSL, or radio frequency monitoring (or any other suitable transmission medium). As is known, a slim design ankle bracelet 124 will preferably communicate with the base unit 122 to identify the defendant's proximity within an allowed perimeter.

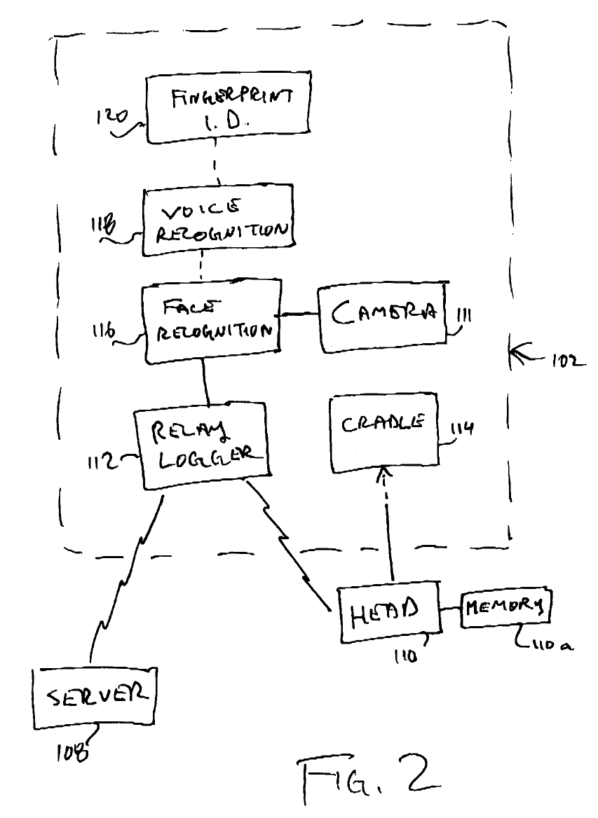

The base unit 122 will preferably allow wireless head 110 to sit in an in-home cradle bracket 126. This will allow for the base unit 122 to synchronize data from interlock device 102 (FIG. 2) and recognize the head 110; this can be accomplished via a hardwired data transmission connection via cradle 126 or via wireless transmission directly from head 110. The head 110 will preferably also receive power from the home base unit cradle 126, thus allowing for ongoing operation and recharging of the head battery.

Random breath tests via head 110, while in-home, can preferably be asked of the defendant by means of an audible tone. A camera unit 128 attached to the home base unit 122 will preferably identify the defendant blowing a sample test and all data can thus be recorded in the head 110 as well as be transmitted to server 108.

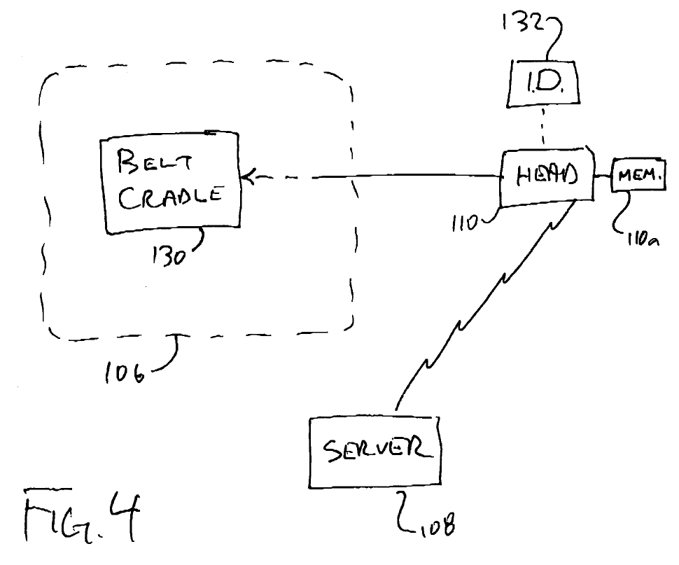

Finally, as shown in FIG. 4, a third component of the three-component system can be embodied by Personal Breath Tester (PBT) 106. By way of brief background, if it is to be assumed that a defendant is complying with an EMHA program and an ignition interlock program in conjunction with one another or even separately, it may well be the case that when the defendant leaves the home during allowed times, jurisdictions may be interested in randomly testing for alcohol while the defendant is mobile. A PBT 106, as broadly contemplated herein will thus allow for such mobile testing. PBT's in general are well known and basic components thereof can readily be employed in the context of embodiments of the present invention; Well-Co produces PBT's having components that can be so employed.

A head 110 as described hereinabove can preferably be body-mounted (e.g., belt-mounted in a belt cradle 130 similar to a cell phone attachment and worn on the person in the same fashion as such). The head 110 will preferably have been programmed at installation with random retest capability and can enter into a “personal breath testing mode” after a predetermined amount of time once it leaves placement from either a vehicle interlock cradle 114 (FIG. 2) or a home base unit cradle 126 (FIG. 3). The PBT function will preferably work throughout the day randomly, requiring the defendant to answer an audible tone prompt by administering a breath test into head 110.

The results of the breath tests will preferably be stored in the head's own data memory 110a and be automatically uploaded to the server 108, e.g., once the head 110 synchronizes with a home base unit cradle 126 (FIG. 3) which communicates (as mentioned before) with server 108

If the PBT device 106 is used in conjunction with ignition interlock device 102 (FIG. 2), then preferably the same sample head 110 will interchangeably synchronize to an “interlock mode” with the vehicle under-dash data logger 112 (FIG. 2). This can preferably occur once the vehicle data logger 112 (FIG. 2) detects that sample head 110 is within range (e.g., by detecting that sample head 110 has been placed in the vehicle's interlock cradle 114 [FIG. 2]).

By way of an advantageous variant, when the head 110 is in a PBT (portable breath tester) mode, it could require the defendant to identify himself or herself; this can be accomplished by ID technology 132 (e.g., fingerprint technology or voice recognition software) that can be integrated into the head 110.

If a failed test is detected over an established threshold, the sample head 110 will preferably immediately prompt for a second test. If two consecutive fails are detected then the unit will preferably communicate through cellular, GSM, or radio frequency technology (or other suitable transmission medium) to server 108, notifying in real time of a problem. The same form of communication can also preferably occur if a requested test is not administered with in a set time period. A test refusal can be logged and communicated as well to server 108.

Preferably, the head is GPS capable and will permit geographical tracking of an offender that is violating the terms of a program.

By way of brief recapitulation, there is broadly contemplated herein a product that economically and efficiently offers jurisdictions at different levels an option of consolidating into one system various separate monitoring devices such as ignition interlock, EMHA, and personal breath testers. Normally, these are three separate types of monitoring devices used in the areas of corrections, criminal sentencing requirements, and legislative mandates imposed upon defendants with in the supervision or authority of a jurisdiction. By integrating three separate devices into one product, the end results can include low costs of manufacture and operation, end-user friendliness, and a consolidated monitoring process.

By way of general background, to provide an even more thorough understanding of the operational context of at least one embodiment of the present invention, a general discussion of ignition interlock arrangements may be found at http://www.mto.gov.on.ca/english/safety/impaired/interlock/. Basic technology for affording breath tests is very widely known and is discussed, for example, at http://science.howstuffworks.com/breathalyzer.htm.

If not otherwise stated herein, it is to be assumed that all patents, patent applications, patent publications and other publications (including web-based publications) mentioned and cited herein are hereby fully incorporated by reference herein as if set forth in their entirety herein.

Although illustrative embodiments of the present invention have been described herein with reference to the accompanying drawings, it is to be understood that the invention is not limited to those precise embodiments, and that various other changes and modifications may be affected therein by one skilled in the art without departing from the scope or spirit of the invention.

What is claimed is:

1. A monitoring system comprising:
a vehicle ignition interlock device;
an EMHA device; and
a mobile breath test arrangement;
said vehicle ignition interlock device, said EMHA device and said mobile breath test arrangement being configured for mutual data exchange.

2. The monitoring system according to claim 1, wherein said vehicle ignition interlock device, said EMHA device and said mobile breath test arrangement are in communication with a common server.

3. The monitoring system according to claim 1, further comprising a portable data collection head integrable with each of said vehicle ignition interlock device, said EMHA device and said mobile breath test arrangement.

4. The monitoring system according to claim 3, wherein said portable data collection head acts to collect breath samples.

5. The monitoring system according to claim 4, wherein said portable data collection head comprises a portable memory for storing data from breath tests.

6. The monitoring system according to claim 3, wherein said vehicle ignition interlock device comprises a cradle for accommodating said portable data collection head.

7. The monitoring system according to claim 3, wherein said vehicle ignition interlock device comprises a relay logger for receiving data from said portable data collection head.

8. The monitoring system according to claim 7, wherein said relay logger acts to communicate with a server common to said vehicle ignition interlock device, said EMHA device and said mobile breath test arrangement.

9. The monitoring system according to claim 3, wherein said vehicle ignition interlock device further comprises a camera.

10. The monitoring system according to claim 9, further comprising a face recognition module integrated with said camera.

11. The monitoring system according to claim 3, wherein said EMHA device comprises a base unit in communication with a server, the server being common to said vehicle ignition interlock device, said EMHA device and said mobile breath test arrangement.

12. The monitoring system according to claim 11, wherein said EMHA device further comprises a cradle for accommodating said portable data collection head, said cradle being in communication with said base unit.

13. The monitoring system according to claim 11, wherein said base unit acts to receive data from said portable data collection head.

14. The monitoring system according to claim 11, wherein said EMHA device comprises a camera for establishing positive identification in conjunction with a test by said portable data collection head.

15. The monitoring system according to claim 3, wherein said mobile breath test arrangement comprises a wearable cradle for accommodating said portable data collection head.

16. The monitoring system according to claim 15, wherein said portable data collection head is in communication with a server, the server being common to said vehicle ignition interlock device, said EMHA device and said mobile breath test arrangement.

17. The monitoring system according to claim 15, wherein said portable data collection head comprises an arrangement for establishing positive identification in conjunction with a test by said portable data collection head.

18. The monitoring system according to claim 3, wherein said portable data collection head acts to prompt random testing in connection with said vehicle ignition interlock device, said EMHA device and said mobile breath test arrangement.
